(19) United States
(12) Patent Application Publication
(10) Pub. No.: US 2005/0179596 A1
(43) Pub. Date: Aug. 18, 2005

(54) Multiband antenna suitable for miniaturization

(75) Inventors: Masahiko Higasa, Fukushima-ken (JP); Masaru Shikata, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/049,484

(22) Filed: Feb. 2, 2005

(30) Foreign Application Priority Data
Feb. 17, 2004 (JP) 2004-040087

(51) Int. Cl. H01Q 1/38

(52) U.S. Cl. 343/700 MS; 343/846

(57) ABSTRACT

First and second radiating conductors are concentrically formed on a top surface of a dielectric substrate, and a grounding conductor is formed on a bottom surface of the dielectric substrate. A feeding pin is connected to a power feeding point of the first radiating conductor. Shorting pins are connected to an inner circumferential portion of the second radiating conductor to be shorted by the grounding conductor. An interval between the radiating conductors allows the first and second radiating conductors to be electromagnetically coupled with each other. When the first radiating conductor is excited at a frequency fH by direct feeding from the feeding pin, the second radiating conductor is fed by the coupling, so that it is excited at a frequency fL lower than the frequency fH.

### BACKGROUND OF THE INVENTION

1. Field of the Invention

The present invention relates to a multiband antenna capable of using a plurality of kinds (for example, two kinds) of resonance frequencies, and more particular, to a small-sized multiband antenna suitable for a vehicle or the like.

2. Description of the Related Art

Recently, automobiles which have mounted an antenna for electronic toll collection system (ETC) having an operation frequency of a 5.8 GHz band or an antenna for global positioning system (GPS) having an operation frequency of a 1.5 GHz band are rapidly increasing. However, since a large space is required to separately mount the antenna for ETC and the antenna for GPS and the mounting work is complicated, multiband antennas capable of using several kinds of resonance frequencies have generally been proposed.

As an example of such a multiband antenna, a structure of a patch antenna has been well known in a conventional art as shown in a plan view of FIG. 7 and a cross-sectional view of FIG. 8 (for example, see Japanese Unexamined Utility Model Registration Application Publication No. 7-38328 (see pages 2 to 3, FIG. 1)). In the dualband antenna 1 shown in these drawings, two kinds of radiating conductor 3 and 4 for high band and low band are concentrically formed on a top surface of a dielectric substrate 2, and a grounding conductor 5 is formed on almost an entire surface of a bottom surface of the dielectric substrate 2. The radiating conductor 3 for high band has a circular shape, and the annular radiating conductor 4 for low band is disposed at a location surrounding the radiating conductor 3 at a sufficient interval. Feeding points of the radiating conductors 3 and 4 are connected to feeding pins 6 and 7 which penetrate the dielectric substrate 2, respectively, and lower end portions of the feeding pins 6 and 7 does not come into contact with the grounding conductor 5 and is connected to a power feeding circuit which is not shown. In addition, shorting walls 8 penetrating the dielectric substrate 2 are connected to an inner circumferential portion of the radiating conductor 4 for low band, and lower ends of the shorting walls 8 are connected to the grounding conductor 5. These shorting walls 8 serve to ensure isolation between the feeding pin 6 for high band and the feeding pin 7 for low band.

The dualband antenna 1 having the above-mentioned structure may excite the radiating conductor 3 with a predetermined frequency fH by performing direct feeding to the radiating conductor 3 for high band through the feeding pin 6. In addition, it may excite the radiating conductor 4 with a frequency fL lower than the frequency fH by performing direct feeding to the radiating conductor 4 for low band through the feeding pin 7.

In addition, as another conventional example, a dualband antenna is known in which a dielectric substrate provided with a radiating conductor for high band is laminated on a dielectric substrate provided with a radiating conductor for low band, and a feeding pin is connected only to the radiating conductor for high band, and feeding to the radiating conductor for low band uses electromagnetic coupling (for example, see ‘EXPLANATORY DIAGRAM ANTENNA’ by Gotou Naohisa published on Jun. 1, 1997, pp. 229, Institute of Electronics, Information and Communication Engineers (IEICE)). In the dualband antenna having such a laminated structure, since the radiating conductor for high band faces the radiating conductor for low band with the dielectric substrate disposed therebetween, the radiating conductor for low band is also excited by the electromagnetic coupling when the radiating conductor for high band is excited through direct feeding by the feeding pin.

In the former conventional example shown in FIGS. 7 and 8, the two kinds of radiating conductors 3 and 4 for high band and low band are concentrically disposed on the same plane of the dielectric substrate 2, so that a compact dualband antenna may be implemented. However, the feeding pins 6 and 7 are respectively connected to the radiating conductors 3 and 4, so that the radiating conductors 3 and 4 should be individually fed. As a result, there is a problem in that the circuit structure is complicated and the high cost is required.

In this regard, in the latter conventional example in which the radiating conductors for high band and low band are electromagnetically coupled with each other, the circuit structure may be simplified. However, the latter conventional example has a structure where two sheets of dielectric substrates are laminated, so that it is difficult to implement the small size and hard to say that it is effective in cost because two metallic moulds for the dielectric substrates are required.

### SUMMARY OF THE INVENTION

Accordingly, the present invention has been made to solve the above-mentioned problems and it is an object of the present invention to provide a multiband antenna capable of simplifying a circuit structure while maintaining a small size and reducing a manufacturing cost.

In order to achieve the above-mentioned objects, according to the present invention, there is provided a multiband antenna which comprises a grounding conductor provided along one plane; first and second radiating conductors disposed on the grounding conductor with a dielectric layer or an air layer interposed therebetween; and a power feeding means for performing direct feeding to the first radiating conductor, wherein the second radiating conductor is disposed at a location which surrounds the first radiating conductor at a predetermined interval, and at least a part of an inner circumferential portion of the second radiating conductor is shorted from the grounding conductor, and the first and second radiating conductors are exited at different frequencies from each other by electromagnetic coupling between the inner circumferential portion of the second radiating conductor and the first radiating conductor when a power is fed to the first radiating conductor.

In the multiband antenna having the above-mentioned structure, since an interval between an inner circumferential portion serving as a shorting portion of the second radiating conductor and an outer circumferential portion of the first radiating conductor is made to be small so that both radiating conductors may be substantially electromagnetically coupled with each other, when the first radiating conductor is excited at a frequency fH by direct power feeding, the second radiating conductor may be excited at a frequency fL lower than the frequency fH. In addition, when a third radiating conductor is disposed at a location which surrounds the second radiating conductor to make both radiating conductors substantially electromagnetically coupled with each other, the third radiating conductor may also be excited at a frequency much lower than the frequency fL. That is, the multiband antenna may allow several kinds of radiating conductors concentrically disposed on the same plane to be excited at different frequencies from each other, which is suitable for implementation of the small size, and separate power feeding is not required, so that the circuit structure may be simplified.

In addition, in the dualband antenna having the above-mentioned structure, for example, the first radiating conductor is preferably formed to be circular while the second radiating conductor is formed to be annular. Alternatively, the first radiating conductor may be square, and the second radiating conductor may be rectangle or the like which surrounds the square.

In addition, in the dualband antenna having the above-mentioned structure, a plurality of shorting pins is preferably disposed along a circumferential direction in the inner circumferential portion of the second radiating conductor and the shorting pines are preferably connected to the grounding conductor. In this case, the second radiating conductor may be effectively electromagnetically coupled when an interval between the adjacent shorting pins is set to be not more than one fourth of a resonance length of the first radiating conductor.

In addition, in the multiband antenna having the above-mentioned structure, the first and second radiating conductors are provided on one surface of the dielectric substrate, and the grounding conductor is provided on the other surface of the dielectric substrate, so that the antenna may be simply fabricated with low cost. In this case, the first and second radiating conductors may be collectively formed on one surface of one sheet of a dielectric substrate while the height of the antenna may be suppressed to about a thickness of the dielectric substrate.

In addition, in the multiband antenna having the above-mentioned structure, the first and second radiating conductors are metal plates, and a metal piece extending from a power feeding point of the first radiating conductor toward the grounding conductor acts to a feeding pin which is isolated from the grounding conductor, and a metal piece extending from the inner circumferential portion of the second radiating conductor toward the grounding conductor is shorted from the grounding conductor, so that the antenna may be simply fabricated with low cost. In this case, all of the first and second radiating conductors, a feeding pins and a shorting means such as a shorting pins or the like may be formed from one sheet of metal plate and the dielectric substrate may be even omitted, so that the fabrication cost may significantly decrease.

In addition, in the multiband antenna having the above-mentioned structure, when degeneracy isolation elements are provided to at least one of the first and second radiating conductors and these radiating conductors are configured so as to radiate circular polarized waves at different frequencies from each other, the first radiating conductor may be used for the ETC, and the second radiating conductor may be used for the GPS, so that it is suitable for a small-sized antenna for an automobile.

According to the dualband antenna of the present invention, when the inner circumferential portion of the second radiating conductor which surrounds the first radiating conductor is shorted from the grounding conductor and the first radiating conductor is excited by direct power feeding, the second radiating conductor is configured to excite at a different frequency by means of the electromagnetic coupling, it is possible to use a plurality of types of resonance frequency while maintaining the small-sized antenna. In addition, separate power feeding is not required, so that the circuit structure may be simplified, which readily leads to the implementation of low cost.

### BRIEF DESCRIPTION OF THE DRAWINGS

FIG. 1 is a plan view of a circular polarized wave antenna for dualband according to a first embodiment of the present invention;

FIG. 2 is a cross-sectional view of the circular polarized wave antenna for dualband;

FIG. 3 is a plan view of a circular polarized wave antenna for dualband according to a second embodiment of the present invention;

FIG. 4 is a plan view of a linearly polarized wave antenna for dualband according to a third embodiment of the present invention;

FIG. 5 is a plan view of a circular polarized wave antenna for dual band according to a fourth embodiment of the present invention;

FIG. 6 is a cross-sectional view of the circular polarized wave antenna for dualband;

FIG. 7 is a plan view of a dualband antenna according to a conventional art; and

FIG. 8 is a cross-sectional view of the circular polarized wave antenna for dualband.

### DESCRIPTION OF THE PREFERRED EMBODIMENTS

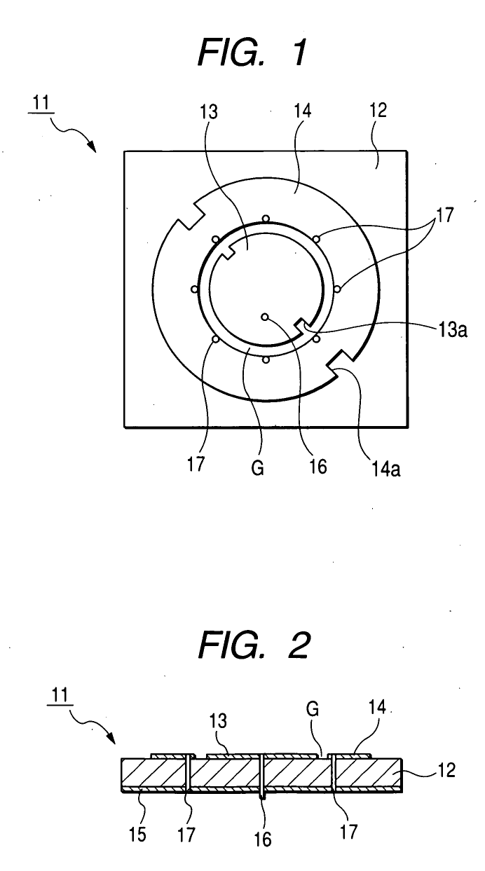

Preferred embodiments of the present invention will be described with reference to the accompanying drawings. FIG. 1 shows a plan view of a circularly polarized wave antenna for dualband according to a first embodiment of the present invention, and FIG. 2 shows a cross-sectional view of the circularly polarized wave antenna for dualband.

In the circularly polarized wave antenna 11 for dualband shown in the drawings, a first radiating conductor 13 for high band and a second radiating conductor 14 for low band are concentrically formed on a top surface of a dielectric substrate 12, and a grounding conductor 15 is formed over a substantially entire surface of a bottom surface of the dielectric substrate 12. The first radiating conductor 13 is circular, and cut-shaped degeneracy isolation elements 13a are provided at two locations of an outer circumferential portion of the first radiating conductor 13 which face each other. The second radiating conductor 14 having an annular shape is disposed at a position which surrounds the first radiating conductor 13 with a predetermined interval G therebetween, and cut-shaped degeneracy isolation elements 14a are also provided at two locations of an outer circumferential portion of the second radiating conductor 14 which face each other. A feeding pin 16 that penetrates the dielectric substrate 12 is connected to a feeding point of the first radiating conductor 13, and a lower end portion of the feeding pin 16 is connected to a feeding circuit that is not shown and does not come into contact with the grounding conductor 15. In addition, a plurality of shorting pins 17, which penetrates the dielectric substrate 12 at equal intervals along a circumferential direction, is connected to an inner circumferential portion of the second radiating conductor 14, and a lower end portion of each shorting pin 17 is connected to the grounding conductor 15.

The first radiating conductor 13 in which the degeneracy isolation elements 13a are provided may be excited with circular polarized waves at a predetermined frequency fH by the direct power feeding from the feeding pin 16. When the first radiating conductor 13 is excited, a strong electric field is generated between the grounding conductor 15 and the outer circumferential portion of the first radiating conductor 13. However, since the interval G is small and a capacitance value is high between the first and second radiating conductors 13 and 14, the current induced to each shorting pin 17 by the electric field is sufficiently high, which allows the second radiating conductor 14 to be power-fed by the electromagnetic coupling. In other words, since the first and second radiating conductors 13 and 14 are substantially electromagnetically coupled with each other, the second radiating conductor 14 in which the degeneracy isolation elements 14a are provided may be excited with circularly polarized waves at a frequency fL lower than the frequency fH by exciting the first radiating conductor 13 with circularly polarized waves at the frequency fH. In addition, in order to make the second radiating conductor 14 effectively electromagnetically coupled, an interval between adjacent shorting pins 17 is preferably set to be less than or equal to one fourth of a resonance length of the first radiating conductor 13.

In the present embodiment, the two kinds of radiating conductors 13 and 14 concentrically disposed on the same plane may be excited with circular polarized waves at different frequencies from each other, so that the first radiating conductor 13 having a small diameter may be used for the ETC and the second radiating conductor 14 having a large diameter may be used for the GPS, which implements the thin-sized dualband antenna 11 suitable for the automobile or the like. Moreover, the dualband antenna 11 may allow the first and second radiating conductors 13 and 14 to be collectively formed on one surface of one sheet of dielectric substrate 12, and the radiating conductors 13 and 14 need not to be separately fed, which may lead to a simplified circuit structure and a simple and low cost fabrication.

Although not shown, it is also possible to excite all the radiating conductors 13 and 14 with circular polarized waves even when the degeneracy isolation elements 13a are provided only in the first radiating conductor 13 or the degeneracy isolation elements 14a are provided only in the second radiating conductor 14, however, it is preferable in antenna performance to provide the degeneracy isolation elements 13a and 14a into the respective radiating conductors 13 and 14 as in the present embodiment. In addition, when a third radiating conductor is disposed at a location which surrounds the second radiating conductor 14 and these radiating conductors are electromagnetically coupled with each other, the third radiating conductor may be excited at a frequency much lower than the frequency fL.

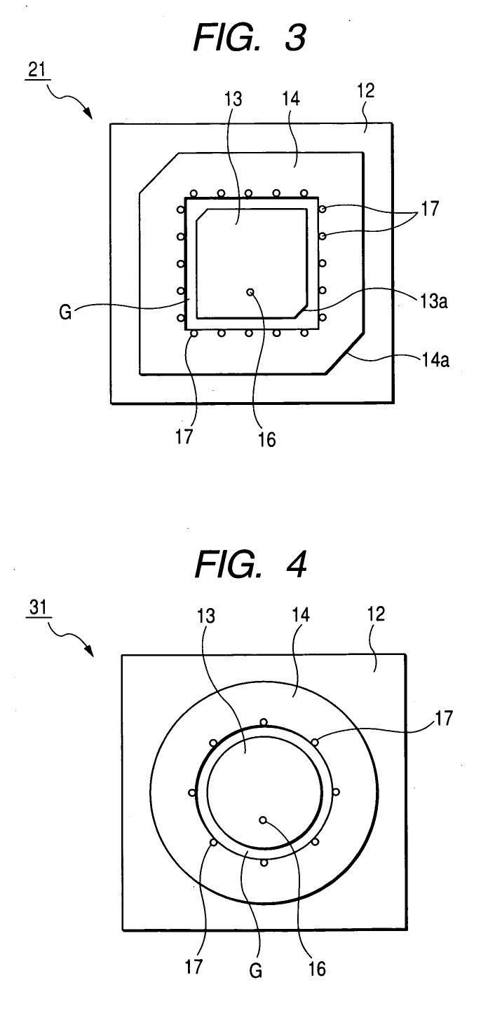

FIG. 3 is a plan view of a circularly polarized wave antenna for dualband according to a second embodiment of the present invention, and has the same reference numerals as those given to the corresponding parts of FIG. 1. The dualband antenna 21 shown in FIG. 3 is different from those in the first embodiment in shapes of the first and second radiating conductors 13 and 14 that are electromagnetically coupled. In other words, the first radiating conductor 13 has a square and cut-shaped degeneracy isolation elements 13a are provided at two locations corresponding to both ends of a diagonal line of the square in the dualband antenna 21, while the second radiating conductor 14 has a rectangular shape which surrounds the square and cut-shaped degeneracy isolation elements 14a are provided at two corner portions corresponding to the two locations at which the degeneracy isolation elements 13a are provided.

FIG. 4 is a plan view of a linearly polarized wave antenna for dualband according to a third embodiment of the present invention, and has the same reference numerals as those given to the corresponding parts of FIG. 1. A dualband antenna 31 shown in FIG. 4 allows the first and second radiating conductors 13 and 14 electromagnetically coupled with each other to be excited with linearly polarized waves at different frequencies from each other. Therefore, the radiating conductors 13 and 14 are formed such that the degeneracy isolation elements are not provided, that is, the first radiating conductor 13 is formed to be circular and the second radiating conductor 14 is formed to be annular. Alternatively, the first radiating conductor 13 may be formed to be square and the second radiating conductor 14 may be formed to be rectangular.

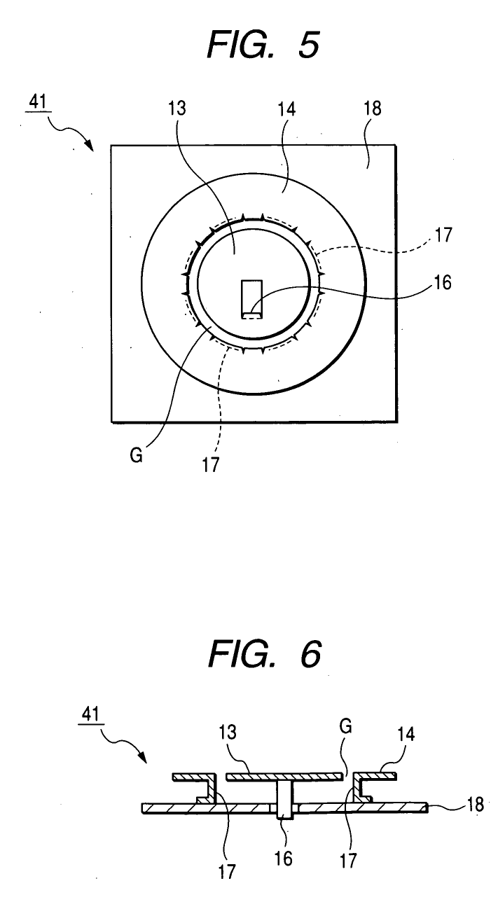

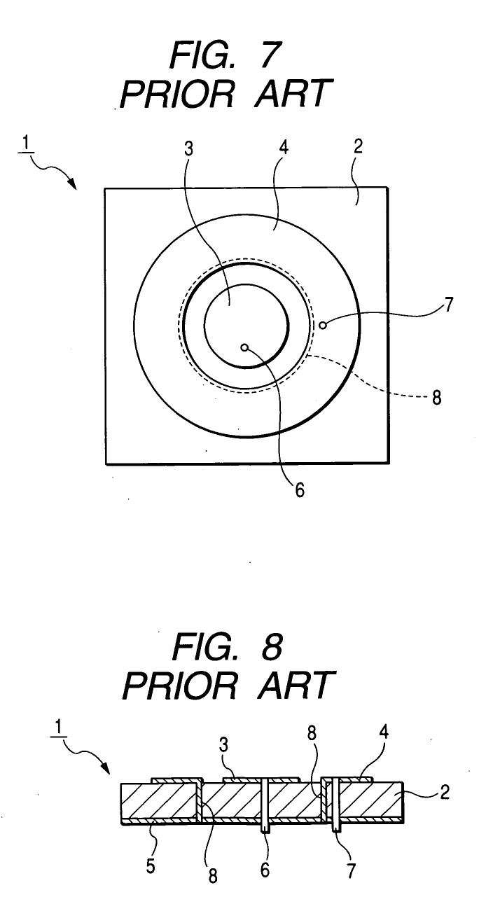

FIG. 5 is a plan view of a linearly polarized wave antenna for dualband according to a fourth embodiment of the present invention, and FIG. 6 is a cross-sectional view of the linearly polarized wave antenna for dualband, where a reference numeral 18 indicates a grounding conductor plate and parts corresponding to FIGS. 1 to 4 are denoted by the same reference numerals. The dualband antenna 41 shown in FIGS. 5 and 6 is a metal plate antenna from which the dielectric substrate is removed, and one sheet of metal plate is used to form all of the first and second radiating conductors 13 and 14, the feeding pin 16, and the shorting pin 17. In other words, the first radiating conductor 13 is a circular metal plate, wherein a metal piece (a cut and erected piece) extending from its feeding point toward the grounding conductor plate 18 serves as the feeding pin 16 away from the grounding conductor plate 18, and the first radiating conductor 13 is supported by the feeding pin 16 above the grounding conductor plate 18. In addition, the second radiating conductor 14 is an annular metal plate which surrounds the first radiating conductor 13 at a predetermined interval G, wherein a plurality of metal pieces (cut and erected pieces) is provided in an inner circumferential portion of the second radiating conductor 14 so as to extend toward the grounding conductor plate 18 at equal intervals along a circumferential direction, and these metal pieces are shorted from the grounding conductor plate 18 to act as the shorting pins 17. In addition, the second radiating conductor 14 is supported by the shorting pins 17 above the grounding conductor plate 18.

Also in the dualband antenna 41 having the above-mentioned structure, by means of the substantial magnetic coupling of the first and second radiating conductors 13 and 14, the respective radiating conductors 13 and 14 may be excited with linearly polarized waves at different frequencies from each other. In addition, the dielectric substrate may be replaced with a metal plate in the case of the dualband antenna 41, so that the fabrication cost may be significantly reduced. In addition, by providing the degeneracy isolation elements in the first radiating conductor 13 or the second radiating conductor 14 in the case of the dualband antenna formed of such a metal plate, it may operate as a circularly polarized wave antenna.

In addition, the plurality of shorting pins 17 is provided in the inner circumferential portion of the second radiating conductor 14 in the above-mentioned embodiments, however, the inner circumferential portion of the second radiating conductor 14 may be shorted to the grounding conductor 15 (or the grounding conductor plate 18) over the overall inner circumferential portion.

1. A multiband antenna comprising:
a grounding conductor provided along one plane;
first and second radiation conductors disposed on the grounding conductor with a dielectric layer or an air layer interposed therebetween; and
a power feeding means for performing direct power feeding to the first radiation conductor,
wherein the second radiation conductor is disposed at a location which surrounds the first radiation conductor at a predetermined interval, and at least a part of an inner circumferential portion of the second radiation conductor is shorted by the grounding conductor, and
the first and second radiation conductors are excited at different frequencies from each other by electromagnetic coupling between the inner circumferential portion of the second radiation conductor and the first radiation conductor when a power is fed to the first radiation conductor.

2. The multiband antenna according to claim 1,
wherein the first radiation conductor is formed to be circular and the second radiation conductor is formed to be annular.

3. The multiband antenna according to claim 1,
wherein a plurality of shorting pins is disposed along a circumferential direction in the inner circumferential portion of the second radiation conductor, and the shorting pins are connected to the grounding conductor.

4. The multiband antenna according to claim 3,
wherein an interval between the adjacent shorting pins is set to be less than or equal to one fourth of a resonance length of the first radiation conductor.

5. The multiband antenna according to claim 1,
wherein the first and second radiation conductors are provided on one surface of the dielectric substrate, and the grounding conductor is provided on an opposing surface of the dielectric substrate.

6. The multiband antenna according to claim 1,
wherein the first and second radiation conductors are metal plates, and a metal piece extending from a power feeding point of the first radiation conductor toward the grounding conductor acts as a power feeding pin which is isolated from the grounding conductor, and a metal piece extending from the inner circumferential portion of the second radiation conductor toward the grounding conductor is shorted by the grounding conductor.

7. The multiband antenna according to claim 1,
wherein a degeneracy isolation element is provided in at least one of the first and second radiation conductors, and the radiation conductors are configured so as to radiate circular polarized waves at different frequencies from each other.
